(19) United States
(12) Patent Application Publication
(10) Pub. No.: US 2020/0067427 A1
(43) Pub. Date: Feb. 27, 2020

(54) Charge Controller for Linear Operation of Piezoelectric Actuators

(71) Applicant: Massachusetts Institute of Technology, Cambridge, MA (US)

(72) Inventors: Kamal YOUCEF-TOUMI, Cambridge, MA (US); Fangzhou XIA, Cambridge, MA (US); Chen YANG, Cambridge, MA (US)

(21) Appl. No.: 16/113,456

(22) Filed: Aug. 27, 2018

(51) Int. Cl. H02N 2/06

(52) U.S. Cl. CPC H02N 2/062

(57) ABSTRACT

A charge controller for controlling a piezoelectric actuator includes a decoupled high-frequency path for controlling the actuator in response to relatively high frequency input signal and a decoupled low frequency path for controlling the actuator in response to a relatively low frequency input signal. The charge controller includes a self-compensating circuit. Features of the charge controller allow for linear control of the piezoelectric actuator without utilizing feedback sensors or complex models.

### BACKGROUND

Due to the advantages of sub-nanometer resolution, prompt response and large output force, piezoelectric actuators (also known as piezo-actuators or PEAs) have been widely used in academia and industry. Representative examples include scanning probe microscopy scanners, micromanipulators, and piezo-motors. However, one major disadvantage of PEAs when being used for precise actuation is the well-known hysteresis effect, which exhibits when applying high electric field to the actuator. The hysteresis causes a nonlinearly in the PEA's response to electrical stimulus. As a result, the positioning accuracy degrades significantly.

Extensive efforts have been directed to compensate this undesired nonlinearity. Generally, these approaches fall into two categories: model-based and model-free methods. In the first category, a mathematical model which describes the hysteretic nonlinearity is constructed and then inverted to implement a feedforward controller. However, some of these models are not suitable for real-time applications because of their complexities. On the other hand, in the second category, piezoelectric hysteresis is usually viewed as an uncertainty, which could be addressed by feedback controllers. The most popular scheme in this category is sensor-based feedback control including a proportional-integral (PI) controller inside the closed feedback loop. However, the shortcomings of feedback control are also distinct: because of the introduction of sensors, the cost and system complexity significantly increase, and the control performance largely depends on the noise level and the bandwidth of the chosen sensor.

### SUMMARY

In an embodiment, a charge controller having a decoupled configuration comprises: a first operational amplifier (op-amp) having a positive terminal and a negative terminal; a sensing capacitor having first and second terminals; and a second op-amp having a first input coupled to a first one of the first and second terminals of the sensing capacitor and a second input coupled to a second one of the first and second terminals of the sensing capacitor. The second op-amp measures the voltage across the sensing capacitor. An output of the second op-amp directly connects to the negative terminal of the first voltage op-amp to keep the voltage across the sensing capacitor equal to an input voltage Vin. A DC offset circuit is coupled to the second terminal of the sensing capacitor. The DC offset circuit comprises a gain circuit and a resistor coupled to the gain circuit and cooperative to provide a DC offset to the piezo-actuator.

One or more of the following features may be included.

The charge controller may include a high frequency signal path and a low frequency signal path. The high frequency path may be configured to control charge to the piezo-actuator in response to a high frequency input signal and the low frequency path may be configured to control charge to the piezo-electric actuator in response to a low-frequency input signal.

The high frequency signal path may comprise the resistor and the sensing capacitor.

The low frequency path may comprise the resistor and an amplifier.

The resistor may be a variable resistor for tuning a response of the charge controller.

The charge controller may include a self-compensating circuit to compensate for a non-linear response of the piezo-actuator.

The self-compensating circuit may comprise: a first amplifier; a second amplifier; a first difference circuit; and a second difference circuit.

The second amplifier circuit may be a variable amplifier circuit for tuning a response of the charge controller.

The self-compensating circuit may be configured to control the charge to the piezo-actuator to compensate for a non-linearity in the response of the piezo-actuator.

The charge controller may include an output node configured to be coupled to a piezoelectric actuator that has a non-linear response.

In another embodiment, a charge controller for controlling a piezo-actuator comprises a high-frequency path. The high frequency path comprises a sensing capacitor, a variable resistor, and the piezo-actuator. A voltage across the sensing capacitor may serve as a voltage source for the piezo-actuator. A low-frequency path is also included. The low-frequency path comprises the variable resistor and an amplifier. In the high-frequency path, the voltage across a sensing capacitor may serve as a voltage source. A variable resistor and the piezo-actuator are connected in parallel to the ground. In response to high-frequency operation, in the high-frequency path, the impedance of the piezo-actuator is relatively smaller than the resistor, such that charge on the sensing capacitor is substantially equal to that of the piezo-actuator. In response to low-frequency operation, in the low-frequency path, an input voltage to the charge controller serves as a voltage source and the sensing capacitor has an impedance characteristic corresponding to a short-circuit.

One or more of the following features may be included.

A self-compensating circuit to compensate for a non-linearity response of the piezo-actuator may be included.

The self-compensating circuit may include a first amplifier; a second amplifier; a first difference circuit; and a second difference circuit.

The second amplifier circuit may be a variable amplifier circuit for tuning a response of the charge controller.

The self-compensating circuit may be configured to control the charge to the piezo-actuator to compensate for a non-linearity in the response of the piezo-actuator.

In another embodiment, a charge controller having a self-compensating configuration includes a first operational amplifier (op-amp) having a first positive input terminal, a first negative input terminal and a first output terminal; and a sensing capacitor having a first terminal coupled to the output terminal of the first op-amp and a second terminal. A second op-amp has a second positive input terminal coupled to the first terminal of the capacitor and a second negative input terminal coupled to a second terminal of the sensing capacitor such that the first op-amp measures the voltage across the sensing capacitor. An output of the first op-amp directly connects to the negative input terminal of the first op-amp to keep the voltage of the sensing capacitor equal to an input voltage Vin. A DC offset circuit has a first terminal coupled to the second terminal of the sensing capacitor and a second terminal coupled to the second input terminal of the first op-amp. The DC offset circuit comprises a gain circuit and a resistor coupled to the gain circuit to provide a DC offset to the piezo-actuator. The charge controller includes self-compensating means to improve a tracking performance of charge controller by utilizing an output of the charge controller.

The self-compensating means may include means for extracting the nonlinearity of the controller output; scaling the extracted nonlinearity; and providing the extracted, scaled, nonlinearity to the non-inverting input terminal of the first op-amp to generate a new input signal.

### BRIEF DESCRIPTION OF THE DRAWINGS

The drawings aid in explaining and understanding the disclosed technology. Since it is often impractical or impossible to illustrate and describe every possible embodiment, the provided figures depict one or more example embodiments. Accordingly, the figures are not intended to limit the scope of the invention. Like numbers in the figures denote like elements.

FIG. 1 is a circuit diagram of a charge controller for controlling a piezoelectric actuator.

FIG. 2 is a circuit diagram of decoupled high- and low-frequency paths of the circuit the charge controller of FIG. 1.

FIG. 3 is an operational block diagram of the charge controller of FIG. 1.

FIG. 4 is a circuit diagram of a charge controller for controlling a piezoelectric actuator.

FIG. 5 is an operational block diagram of the charge controller of FIG. 4.

FIG. 6 is a series of graphs illustrating compensation of a charge controller for nonlinearity of a piezoelectric actuator.

FIG. 7 is a series of graphs illustrating compensation of a charge controller for nonlinearity of a piezoelectric actuator.

FIG. 8 is a graph of a gain circuit's gain constant versus input frequency.

### DETAILED DESCRIPTION

A charge control scheme for controlling a PEA may fully utilize the physical properties of the PEA instead of the input-output characteristics of the piezoelectric materials to account for the hysteretic nonlinearity. Specifically, by keeping the free charge of a PEA as a linear function of input signal, the hysteresis effect could be effectively eliminated. An advantage of the charge control scheme is that high-precision motion control can be achieved in a sensorless way, without modeling the hysteretic nonlinearity. These features make it particularly suitable for real industrial applications.

The disclosed embodiments provide a novel solution which solves all of these difficulties, thus achieving high performance motion control of PEAs in a wide frequency range. One aspect of at least some of the disclosed embodiments is a grounded-load charge controller with so-called decoupled configuration. In this configuration, high-frequency and low-frequency paths are essentially decoupled. As a result, the transition frequency may be arbitrarily set which may extend the effective operational range and solve the issue of long settling time. Moreover, the decoupled nature also eases the match of DC and AC voltage gains. With a ground-loaded scheme, the issues of stroke reduction and lack of universality have also been overcome.

As the performance of charge controllers will inevitably degrade when operating around the transition frequency, a self-compensating scheme is proposed. In this scheme, the hysteresis compensation capability of the proposed charge controller may be further strengthened by extracting the nonlinearity of the controller output and then feeding it back to the input. Thus, the frequency-dependent control performance may be greatly improved.

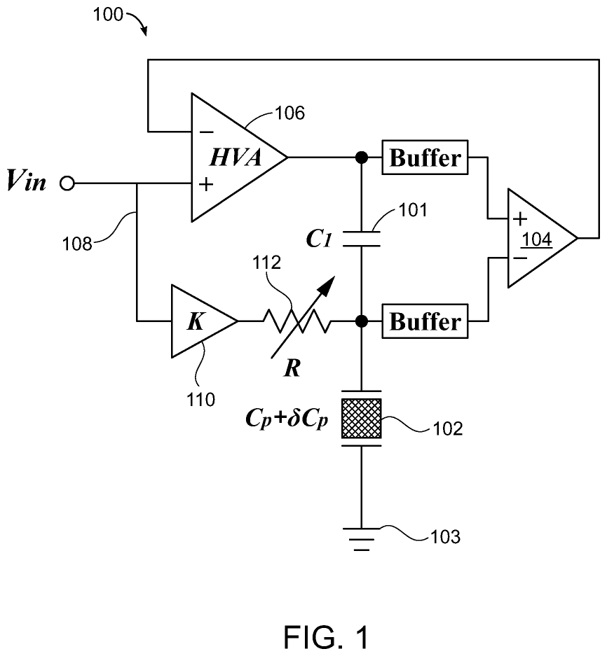

Referring to FIG. 1, a charge controller circuit 100 for controlling a piezo-actuator 102 may be configured to have a so-called decoupled configuration, where a first path is responsive to high frequency input and a second path is responsive to low frequency input. Resistive DC feedback path has been demonstrated to be effective for drift cancellation.

Long setting time of the piezo-actuator can be attributed to prior art circuits with coupled low-frequency and high-frequency paths. Therefore, an advantage of a charge controller 100 with decoupled low- and high-frequency paths is that a shorter settling time may be achieved.

In FIG. 1, Cₚ and δCₚ are used to represent the modeling of the PEA. Cₚ represents a constant and dominant capacitance of the piezo-actuator 102, while δCₚ stands for its nonlinear deviation. The controller circuit may be designed to be ground-loaded, so that issues such as stroke reduction and not being suitable for piezo-tube actuators can be effectively solved. Therefore, in embodiments, one side of piezo-actuator 102 may be coupled to ground terminal 103. Piezo-actuator 102 may be ground-loaded. For example, one terminal of piezo-actuator 102 may be coupled to ground while the other may be coupled to a non-zero voltage signal.

Charge controller 100 may include a capacitor 101, which may be used to sense the charge coupled to PEA 102. Capacitor 101 may be referred to as a sensing capacitor for this reason. An operational amplifier (“op-amp”) 104 may be coupled so that its negative input terminal is coupled to one side of capacitor 101 and its positive input terminal is coupled to the other side of capacitor 101. In embodiments, op-amp 104 may be a unity-gain differential op-amp and may be configured to measure the voltage across capacitor 101.

Charge controller 100 may also include op-amp 106, which may be rated for high voltage input and/or output. The output terminal of op-amp 104 may be coupled to the negative input terminal of op-amp 106. Input voltage signal 108 (which may be a control signal for controlling piezo-actuator 102) may be coupled to the positive input terminal of op-amp 106. The output terminal of op-amp 106 may be coupled to one side of capacitor 101. The other side of capacitor 101 may be coupled to piezo-actuator 102.

Charge controller 100 may also include a gain circuit 110 with gain K and a resistor 112. Resistor 112 may be a variable resistor and may be used for tuning charge controller 100.

The output of op-amp 104, connected to the negative input terminal of op-amp 106, may cause the voltage across capacitor 101 to remain equal to the input voltage signal 108. Meanwhile, gain circuit 110 and resistor 112 may provide a DC offset to piezo-actuator 102.

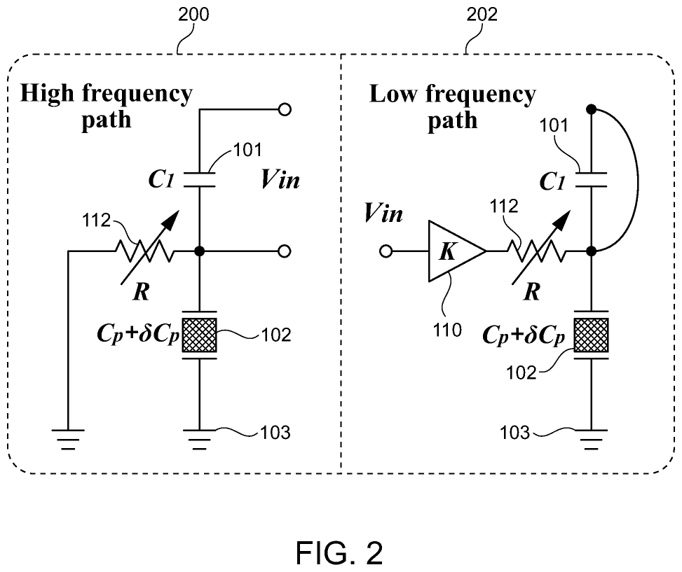

Referring to FIG. 2, charge controller 100 is displayed as a high-frequency path 200 and a low-frequency path 202. According to the theory of superposition, the controller circuit can be divided into two decoupled parts: a high-frequency path 200 and a low-frequency path 202

In high-frequency path 200, the voltage across the sensing capacitor 101 serves as a voltage source for PEA 102. Resistor 112 and PEA 102 are connected in parallel to ground 103. Because, at high frequency, the impedance of PEA 102 may be much smaller than resistor 112, the resistive branch can be viewed as being an open circuit. In other words, the charge on capacitor 101 may be equal to the charge on PEA 102.

In low-frequency path 200, input voltage signal 108 serves as a voltage source for PEA 102. Thus, capacitor 101 can be viewed as being short-circuited. Because of the large impedance of the PEA, when operating at low-frequencies the DC components of Vᵢₙ (for example the resistor and the gain circuit) provide a DC offset to the PEA 102. Therefore, low-frequency path provides a DC voltage (e.g. a DC offset) across PEA 102. DC voltage is considered to have essentially frequency of 0, which may effectively yield infinite impedance for the PEA when compared to the finite resistor 112 viewed as a voltage divider. Thus, under these circumstances, the DC voltage across the PEA 102 may essentially be equal to the DC voltage applied at Vᵢₙ.

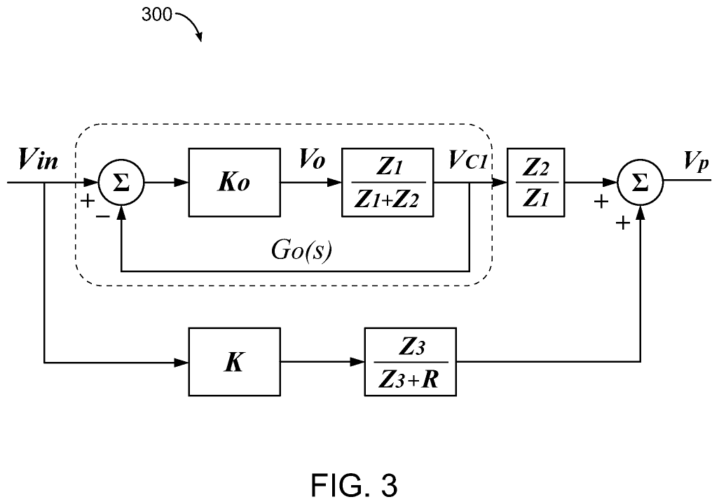

Referring to FIG. 3, block diagram 300 provides an example of an operational model of charge controller 100. The transfer function of the small internal loop Gₒ(s) is

$$\begin{matrix}{G}_{0} ( s ) = \frac{{K}_{o} {Z}_{1} ( s )}{( 1 + {K}_{o} ) {Z}_{1} ( s ) + {Z}_{2} ( s )} \\ where & ( 1 ) \\ {Z}_{1} ( s ) = \frac{1}{{C}_{1} s} & ( 2 ) \\ {Z}_{2} ( s ) = \frac{R}{R ( {C}_{p} + δ {C}_{p} ) s + 1} & ( 3 )\end{matrix}$$

As the open-loop gain Kₒ of op-amp 106 is more than 100 dB, it may be viewed as infinity for simplification. Moreover, Z₃(s) is defined as

$${Z}_{3} ( s ) = \frac{1}{( {C}_{p} + δ {C}_{p} ) s} \qquad ( 4 )$$

Thus the transfer function from Vᵢₙ(s) to Vₚ(s) is

$${V}_{p} ( s ) = \frac{{RC}_{1} s}{R ( {C}_{p} + δ {C}_{p} ) s + 1} {V}_{i n} ( s ) + \frac{K}{R ( {C}_{p} + δ {C}_{p} ) s + 1} {V}_{i n} ( s ) \qquad ( 5 )$$

which is equal to

$${V}_{p} ( s ) = \frac{{C}_{1}}{{C}_{p} + δ {C}_{p}} \frac{s + K / {RC}_{1}}{s + 1 / R ( {C}_{p} + δ {C}_{p} )} {V}_{i n} ( s ) \qquad ( 6 )$$

The constant gain K is set to

$$K = \frac{{C}_{1}}{{C}_{p}} \qquad ( 7 )$$

Substituting (9) into (8) gives

$${G}_{1} ( s ) = \frac{{V}_{p} ( s )}{{V}_{i n} ( s )} = \frac{{C}_{1}}{{C}_{p} + δ {C}_{p}} \frac{s + 1 / {RC}_{1}}{s + 1 / R ( {C}_{p} + δ {C}_{p} )} \qquad ( 8 )$$

Thus the transition frequency of the controller is

$${f}_{c} = \frac{1}{2 π R ( {C}_{p} + δ {C}_{p} )} \qquad ( 9 )$$

The transition frequency f_{c} defines whether the low-frequency path 202 or high-frequency path 200 is driving PEA 102. At frequencies below the transition frequency, low-frequency path 202 drives PEA 102. At frequency above the transition frequency, high-frequency path 200 drives PEA 102. For example, when operating at frequencies much higher (e.g. 10 times higher) than the transition frequency, the high-frequency 200 path plays a dominant role in controlling charge to PEA 102. When operating at frequencies much lower than the transition frequency, the low-frequency path 202 plays a dominant role in controlling charge to PEA 102. When operating at frequencies near the transition frequency, both high-frequency path 200 and low-frequency path 202 may operate to control PEA 102. For example, since a real-world circuit may not be able to provide a perfect frequency cutoff at the transition frequency, there will be at least some frequency band within which both the high-frequency path 200 and low-frequency path 200 operate on PEA 102.

According to formula (9), the transition frequency f_{c} depends on the value of the resistor 112. If resistor 112 is a variable resistor, the transition frequency can be arbitrarily set or tuned by changing the resistance of resistor 112. Moreover, another advantage of this decoupled design lies in that the settling time of the controller circuit can be very well controlled. A relatively small resistance applied to resistor 112 may increase the current flowing into PEA 102, which may reduce the time PEA 102 takes to settle.

The amplitude-frequency characteristic of charge controller 100 may be G₁(s), which may be expressed as:

$${\vert {G}_{1} ( s ) \vert}_{s = j ω} = \vert \frac{{V}_{p} ( j ω )}{{V}_{i n} ( j ω )} \vert = \frac{{C}_{1}}{{C}_{p}} \sqrt{\frac{1 + {ω}^{2} {C}_{p}^{2} {R}^{2}}{1 + {{ω}^{2} ( {C}_{p} + δ {C}_{p} )}^{2} {R}^{2}}} \qquad ( 10 )$$

By defining

$$β ( ω ) = \frac{{ω}^{2} {R}^{2} {C}_{p}^{2}}{1 + {ω}^{2} {R}^{2} {C}_{p}^{2}} ∈ [ 0 , 1 ) \\ where ω ∈ [ 0 , ∞ ) \qquad ( 11 )$$

Then equation (10) can be rewritten as

$$\vert \frac{{V}_{p} ( j ω )}{{V}_{i n} ( j ω )} \vert = \frac{{C}_{1}}{\sqrt{( 1 - β ( ω ) ) {C}_{p}^{2} + β ( ω ) {( {C}_{p} + δ {C}_{p} )}^{2}}} \qquad ( 12 )$$

which gives a clear indication that when ω→0, then β(ω)→0, and consequently Vₚ and Vᵢₙ are linearly related. This effect can be described as

$$\vert \frac{{V}_{p} ( j ω )}{{V}_{i n} ( j ω )} \vert = \{ \begin{matrix}\frac{{C}_{1}}{{C}_{p}} & when ω \to 0 \\ \frac{{C}_{1}}{{C}_{p} + δ {C}_{p}} & when ω \to ∞\end{matrix} \qquad ( 13 )$$

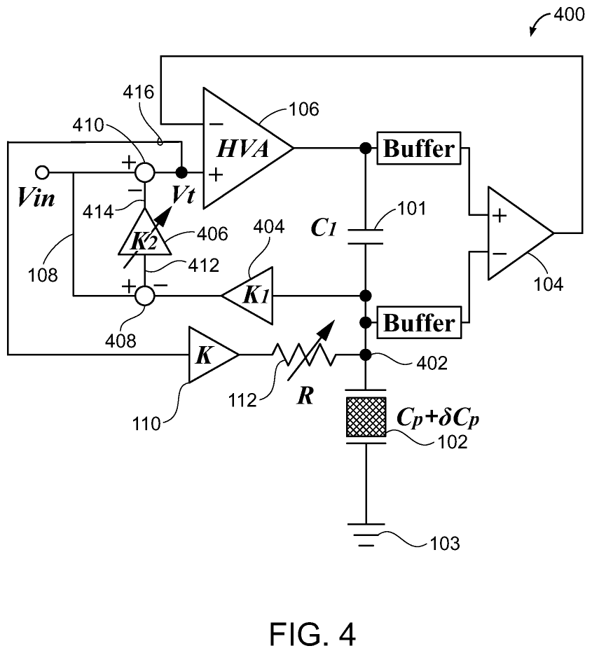

Referring to FIG. 4, an example charge controller 400 may include decoupled high- and low-frequency paths for controlling PEA 102, as described above. Charge controller 400 may include op-amps 104 and 106, gain circuit 110, resistor 112, and capacitor 101 as described above. Charge controller 400 may also include a self-compensating circuit to compensate for a non-linear response of PEA 102. In embodiments, the self-compensating circuit may improve tracking performance of charge controller 400 may utilize an output signal (e.g. the voltage at node 402) of charge controller 400.

In an embodiment, the self-compensating circuit may comprise gain circuit 404, gain circuit 406, and difference circuits 408 and 410. Gain circuit 406 may be a variable gain circuit that can be tuned to optimize performance of charge controller 400.

In embodiments, the self-compensating circuit of charge controller 400 may improve tracking performance of charge controller at input frequencies around the transition frequency f_{c}. For example, setting the transition frequency to be sufficiently low, the effective operational range of the charge controller may be enlarged. However, this may require the use of a large variable resistor 112, which may reduce the charge controller's immunity to drift and increase the thermal noise level.

The self-compensating scheme may strengthen the nonlinearity of compensating signal by using its own output (i.e. the voltage at node 402) to provide compensating capability even when operating around the transition frequency. Gain circuit 404 may extract and scale down the nonlinearity of the controller output by a constant gain K₁. Difference circuit 408 may produce a signal 412 representing the difference between the output of gain circuit 404 and input voltage signal 108. Gain circuit 406 may then further scale the nonlinearity of output signal 402 by applying gain K₂ to produce signal 414. The difference between input signal 108 and signal 414 (i.e. signal 416 produced by difference circuit 410) may then be fed back to the positive input terminal of op-amp 106 to generate a new input signal Vₜ, which may represent a self-compensated input signal.

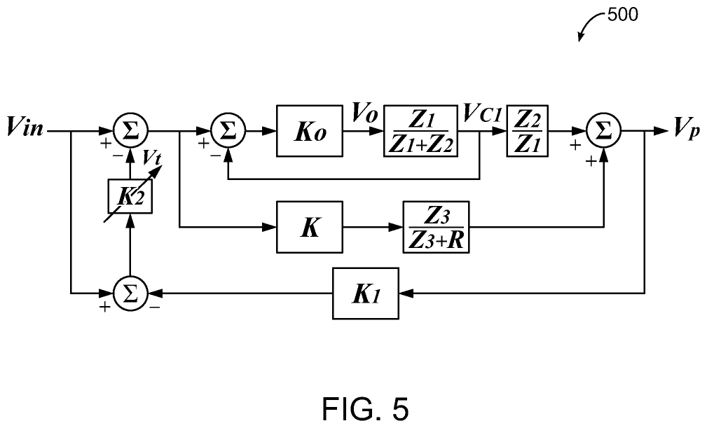

Referring to FIG. 5, the self-compensating configuration of charge controller 400 may effectively add a new feedback loop into the previously-described charged controller 100. According to block diagram 500:

$$\begin{matrix}( {V}_{i n} ( s ) - {K}_{1} {V}_{p} ( s ) ) {K}_{2} = {V}_{t} ( s ) & ( 14 ) \\ \frac{( {V}_{i n} ( s ) - {V}_{t} ( s ) ) K - {V}_{p} ( s )}{R} + \frac{{V}_{i n} ( s ) - {V}_{t} ( s )}{1 / {C}_{1} s} = \frac{{V}_{p} ( s )}{1 / ( {C}_{p} + δ {C}_{p} ) s} & ( 15 )\end{matrix}$$

Thus, the transfer function G₂(s) from Vᵢₙ to Vₚ is

$${G}_{2} ( s ) = \frac{{V}_{p} ( s )}{{V}_{i n} ( s )} = \frac{{C}_{1}}{{C}_{p}} \frac{s + 1 / {RC}_{p}}{[ 1 + δ {C}_{p} / {C}_{p} ( 1 - {K}_{2} ) ] s + 1 / {RC}_{p}} \qquad ( 16 )$$

By using the same definition of β(ω) as in (13), the amplitude frequency characteristic of G₂(s) can be obtained as

$$\begin{matrix}\begin{matrix}{\vert {G}_{2} ( s ) \vert}_{s = j ω} = \vert \frac{{V}_{p} ( j ω )}{{V}_{i n} ( j ω )} \vert \\ = \frac{{C}_{1}}{\sqrt{( 1 - β ( ω ) ) {C}_{p}^{2} + β ( ω ) {( {C}_{p} + δ {C}_{p} / ( 1 - {K}_{2} ) )}^{2}}} \\ = \frac{{C}_{1}}{\sqrt{{C}_{p}^{2} + 2 β ( ω ) {C}_{p} δ {C}_{p} / ( 1 - {K}_{2} ) + β ( ω ) δ {C}_{p}^{2} / {( 1 - {K}_{2} )}^{2}}}\end{matrix} & ( 17 ) \\ \sqrt{{C}_{p}^{2} + 2 β ( ω ) {C}_{p} δ {C}_{p} / ( 1 - {K}_{2} ) + β ( ω ) δ {C}_{p}^{2} / {( 1 - {K}_{2} )}^{2}} \approx \sqrt{{C}_{p}^{2} + 2 β ( ω ) {C}_{p} δ {C}_{p} / ( 1 - {K}_{2} )} & ( 18 )\end{matrix}$$

Similarly, we have

\sqrt{(Cₚ+δCₚ)²}≈\sqrt{Cₚ²+2CₚδCₚ} (21)

Thus, by carefully choosing the value of K₂∈(0,1), the frequency-dependent effect represented by f/(co) can be compensated, meaning that

\sqrt{Cₚ²+2β(ω)CₚδCₚ/(1−K₂)}=\sqrt{Cₚ²+2CₚδCₚ} (19)

Thus, equation (16) can be simplified as

$${\vert {G}_{2} ( s ) \vert}_{s = j ω} = \vert \frac{{V}_{p} ( j ω )}{{V}_{i n} ( j ω )} \vert = \frac{{C}_{1}}{{C}_{p} + δ {C}_{p}} \qquad ( 23 )$$

This equation indicates that when operating in the low-frequency range, the proposed self-compensating charge controller may have similar performance as when it is operating at higher frequencies. However, it is worth noting that the system tends to be unstable when K₂ is close to 1. Thus K₂ has to be determined experimentally. The performance of the proposed controller will be detailed in the next section.

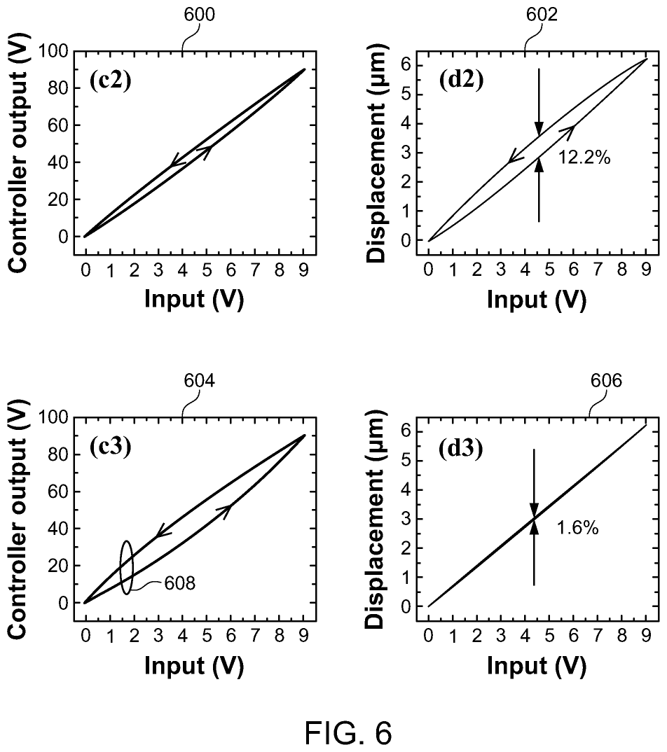

Referring to FIG. 6, graphs 600-606 illustrate the performance of charge controllers while controlling a PEA. Graph 600 represents the input v. output curve of a charge controller. Graph 602 represents the input v, output curve of charge controller 100 and/or charge controller 400. In graph 602, the horizontal axis represents input voltage signal 108 and the vertical axis represents the voltage across PEA 102.

Graph 604 illustrates the displacement of a PEA being controlled by a charge controller. Graph 606 illustrates the displacement of a PEA being controlled by charge controller 100 and/or 400. In graph 606, the horizontal axis represents the input voltage signal 108 and the vertical axis represents displacement of PEA 102.

As illustrated in graph 602, charge controllers of the prior art may produce a non-linearity of about 12% due to hysteresis in the displacement of the PEA. However, as shown in graph 604, a charge controller with decoupled high- and low-frequency paths and/or a self-compensation circuit like those described above may produce a compensated output curve 608. For example, the self-compensating feedback of charge controller 400 may result in an output curve 608 that compensates for the nonlinear hysteresis of PEA 102. As a result, the nonlinearity of PEA 102 may be reduced from 12% to 1.6% or less, as shown by graph 606.

Experimental results of the charged controllers described above show improved performance in controlling a PEA. The proposed charge controller circuit was implemented based on four PA88 power amplifiers (APEX, USA). Table I lists the parameters of the controller circuit. The frequency response of the controller circuit was conducted from DC to 6 kHz. The bandwidth of the embodiment that was implemented in circuitry is approximately 4.1 kHz.

TABLE I
PARAMETERS OF AN EXAMPLE CHARGE CONTROLLER
CIRCUIT

| | |
|---|---|
| Resistor | R = 33.55 MΩ |
| Input capacitor | Cₗ = 6.78 μF |
| PSA's capacitance | Cₚ = 0.678 μF |
| Voltage gain | 10 V/V |
| Transition frequency | 0.007 Hz |

The actuator used was a P-885.11 multilayer piezoelectric stack actuators (Physik Instrumente), with a full operating voltage of 100 V, a nominal travel range of 6.5 μm and a nominal capacitance of 0.678 μF.

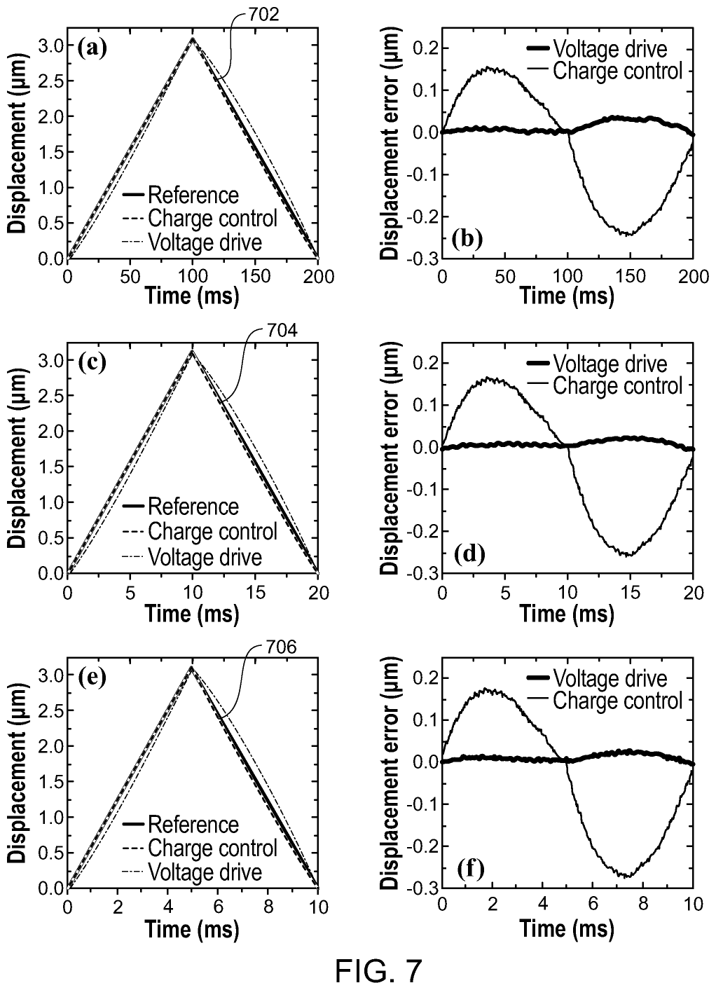

Referring to FIG. 7, in the experiments, triangular waveforms 702-706 of different frequencies were chosen as input signals since they are essentially linear in both ascending and descending branches. Such signals were then sent to the charge controller and collected with a data acquisition card (DAQ-2010, ADLINK Technology). Two semiconductor strain gauges (SSGH-080-050-120PB, Micron Instruments) with gauge factor of 120±10 were integrated with the PSA as high sensitivity displacement sensors.

By calibrating the output of strain gauge with a capacitive sensor (capa-NCDT6500, Micro-Epsilon), the sensitivity was found to be 1.49 V/μm.

Referring again to FIG. 6, during a test, the piezo-actuator 102 was driven from 0 to 90 V, i.e. 90% of the travel range. As the transition frequency was set to 0.007 Hz, when operating at 0.1 Hz (more than 10 times higher than transition frequency) the charge controller showed compensating capability with a displacement error around 1.5% of the travel range. When operating at 0.01 Hz the tracking error reached 12.2% of the motion range, as shown in graph 602. The nonlinear deviation degraded more than 50%, as shown in graph 600. To recover the nonlinear deviation of controller output, thus achieving high precision motion control at 0.01 Hz, the self-compensating technique has been used. In one embodiment, by adjusting the value of K₂, for example, the nonlinear deviation of the controller output was amplified about 2.6 times (as shown in graph 604) and the tracking error was reduced to 1.6% of the maximum stroke (as shown in graph 606). In embodiments, the reduced nonlinearity of controller output can be fully recovered by charge controller 100 and/or 400.

Charge controllers like charge controller 100 and/or 400 were used to test a high-speed atomic force microscope (HS-AFM). The increased linearity of PEAs controlling the microscope resulted in more accurate imaging while using a charge controller with a decoupled configuration and/or self-compensating circuits. Microscope control may require low frequency charge controller operation, for example in the range of about several milli-hertz, which is below the operating bandwidth of most of the charge controllers of the prior art.

To demonstrate that hysteretic nonlinearity could be compensated in a wide range, charge controllers are employed for both axes of the AFM. Considering that normal AFM scanners have difficulty achieving high scan rates up to 100 Hz, the experimental setup used in this section was a custom designed high-speed AFM, which included a high-bandwidth tripod scanner. Charge controllers were employed to compensate the hysteresis of piezoelectric actuators in both X- and Y-axes. Results are summarized in Table III. The results of operating the AFM with charge controller 100 and/or 400 are shown in the bottom row, labeled “CC 100/400.”

TABLE III
PERFORMANCE COMPARISON OF CHARGE CONTROLLERS

| | Effective | | | |
|---|---|---|---|---|
| | operating | | Maximum | |
| | frequencies | Settling time | tracking error | Load connection |
| Ref. | (Hz) | (s) | (%) | type |
| | 0.1-10 | <1 | <1.3 | Floating load |
| | unknown | unknown | <0.86 | Grounded load |
| | 1-100 | unknown | <0.76 | Floating load |
| | 0.01-20 | no | <2% | Floating load |
| | Unknown | 10.9 | <1 | Floating load |
| CC100/ | 0.01-100 | <1 | <1.6% | Grounded load |
| 400 | | | | |

Charge controller 100 and/or 400 may dramatically suppress piezoelectric hysteresis. The experimental results indicate good tracking performance of the charge controller 100 and/or 400, especially when integrating self-compensating technique into the circuit.

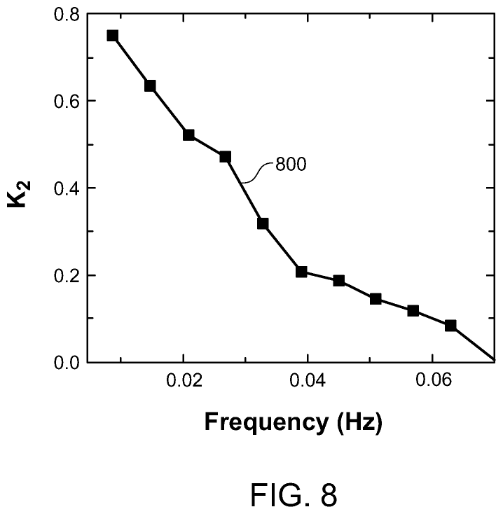

Referring to FIG. 8, waveform 800 provides the value of tunable gain K₂ at each frequency during experimentation. From 0.009 Hz to 0.039 Hz, the value of K₂ varies dramatically. After that, the curve becomes much flatter, until reaching 10 times of transition frequency, where K₂=0.

From the view of control theory, charge controller 100 and/or 400 may be viewed as a feedforward controller. For example, charge controller 100 and/or 400 may utilize the physical property of piezoelectric material, but not the input-output characteristics to reduce the hysteresis effect. Therefore, complicated modeling and parameter identification processes may not be necessary. If gain circuit 406 is adjustable, a range of the operating bandwidths may be chosen by adjusting the gain of gain circuit 406.

The decoupled nature of the controller circuit may result in the gain-matching process being easy to implement. The AC gain is determined by the ratio of C1 and Cp, while the DC gain only depends on the value of the gain of gain circuit 110. Therefore, by making K equal to C1/Cp, a constant voltage gain can be achieved over the whole operating range.

Charge controller 100 and/or 400 may solve a long-standing issue of limited low-frequency performance in prior art charge controllers. Due to the decoupled nature, arbitrarily low transition frequency of charge controller 100 and/or 400 can be achieved without suffering from the issues of long settling time, floating-load and loss of stroke. The self-compensating configuration improves control performance even when operating close to the transition frequency, leading to an extension of bandwidth of about one order of magnitude. In addition, charge controllers 100 and/or 400 do not require feedback sensors or complicated models of inherent PEA non-linearity to operate a PEA in a substantially linear fashion over a wide bandwidth.

Having described one or more preferred embodiments, which serve to illustrate various concepts, structures and techniques, and which are the subject of this patent, it will now become apparent to those of ordinary skill in the art that other embodiments incorporating these concepts, structures and techniques may be used. Accordingly, the scope of the patent should not be limited to the described embodiments but rather should be limited only by the spirit and scope of the following claims. All references cited in this patent are incorporated by reference in their entirety.

1. A charge controller having a decoupled configuration, the charge controller comprising:
a first operational amplifier (op-amp) having a positive terminal and a negative terminal;
a sensing capacitor having first and second terminals;
a second op-amp having a first input coupled to a first one of the first and second terminals of the sensing capacitor and a second input coupled to a second one of the first and second terminals of the sensing capacitor such that the second op-amp measures the voltage across the sensing capacitor and wherein an output of the second op-amp directly connects to the negative terminal of the first voltage op-amp to keep the voltage across the sensing capacitor equal to an input voltage Vin;
a DC offset circuit coupled to the second terminal of the sensing capacitor, the DC offset circuit comprising:
a gain circuit; and
a resistor coupled to the gain circuit and cooperative to provide a DC offset to the piezo-actuator.

2. The charge controller of claim 1 further comprising a high frequency signal path and a low frequency signal path, wherein the high frequency path is configured to control charge to the piezo-actuator in response to a high frequency input signal and the low frequency path is configured to control charge to the piezo-electric actuator in response to a low-frequency input signal.

3. The charge controller of claim 2 wherein the high frequency signal path comprises the resistor and the sensing capacitor.

4. The charge controller of claim 2 wherein the low frequency path comprises the resistor and an amplifier.

5. The charge controller of claim 1 wherein the resistor is a variable resistor for tuning a response of the charge controller.

6. The charge controller of claim 1 further comprising a self-compensating circuit to compensate for a non-linear response of the piezo-actuator.

7. The charge controller of claim 6 wherein the self-compensating circuit comprises: a first amplifier; a second amplifier; a first difference circuit; and a second difference circuit.

8. The charge controller of claim 7 wherein the second amplifier circuit is a variable amplifier circuit for tuning a response of the charge controller.

9. The charge controller of claim 6 wherein the self-compensating circuit is configured to control the charge to the piezo-actuator to compensate for a non-linearity in the response of the piezo-actuator.

10. The charge controller of claim 1 further comprising an output node configured to be coupled to a piezoelectric actuator, the piezoelectric actuator having a non-linear response.

11. A charge controller for controlling a piezo-actuator, the charge controller comprising:
a high-frequency path comprising a sensing capacitor, a variable resistor, and the piezo-actuator, wherein a voltage across the sensing capacitor service as a voltage source for the piezo-actuator;
a low-frequency path comprising the variable resistor and an amplifier;
wherein, in the high-frequency path, the voltage across a sensing capacitor serves as a voltage source, and a variable resistor and the piezo-actuator are connected in parallel to the ground;
wherein in response to high-frequency operation, in the high-frequency path, the impedance of the piezo-actuator is relatively smaller than the resistor, such that charge on the sensing capacitor is substantially equal to that of the piezo-actuator; and
wherein in response to low-frequency operation, in the low-frequency path, an input voltage to the charge controller serves as a voltage source and the sensing capacitor has an impedance characteristic corresponding to a short-circuit.

12. The charge controller of claim 11 further comprising a self-compensating circuit to compensate for a non-linearity response of the piezo-actuator.

13. The charge controller of claim 12 wherein the self-compensating circuit comprises: a first amplifier; a second amplifier; a first difference circuit; and a second difference circuit.

14. The charge controller of claim 13 wherein the second amplifier circuit is a variable amplifier circuit for tuning a response of the charge controller.

15. The charge controller of claim 12 wherein the self-compensating circuit is configured to control the charge to the piezo-actuator to compensate for a non-linearity in the response of the piezo-actuator.

16. A charge controller having a self-compensating configuration, the charge controller comprising:
a first operational amplifier (op-amp) having a first positive input terminal, a first negative input terminal and a first output terminal;
a sensing capacitor having a first terminal coupled to the output terminal of the first op-amp and a second terminal;
a second op-amp having a second positive input terminal coupled to the first terminal of the capacitor and a second negative input terminal coupled to a second terminal of the sensing capacitor such that the first op-amp measures the voltage across the sensing capacitor and wherein an output of the first op-amp directly connects to the negative input terminal of the first op-amp to thereby keep the voltage of the sensing capacitor equal to an input voltage Vin;
a DC offset circuit having a first terminal coupled to the second terminal of the sensing capacitor and a second terminal coupled to the second input terminal of the first op-amp, the DC offset circuit comprising:
a gain circuit; and
a resistor coupled to the gain circuit to provide a DC offset to the piezo-actuator; and
self-compensating means to improve a tracking performance of charge controller by utilizing an output of the charge controller.

17. The charge controller of claim 16 wherein the self-compensating means comprises means for extracting the nonlinearity of the controller output, scaling the extracted nonlinearity and providing the extracted, scaled, nonlinearity to the non-inverting input terminal of the first op-amp to generate a new input signal Vₜ.
